(19) United States
(12) Patent Application Publication
(10) Pub. No.: US 2007/0099067 A1
(43) Pub. Date: May 3, 2007

(54) Polymer catalyst composite as a membrane electrode assembly in Direct Methanol Fuel Cells

(76) Inventor: Sanjiv Malhotra, Castro Valley, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/527,737

(22) Filed: Sep. 25, 2006

Related U.S. Application Data
(60) Provisional application No. 60/720,174, filed on Sep. 23, 2005.

(51) Int. Cl. H01M 4/86

(52) U.S. Cl. 429/42; 429/44

(57) ABSTRACT

A polymer catalyst composite is provided that can act as a membrane or a membrane electrode assembly in a direct methanol fuel cell. The polymer catalyst composite distinguishes two components. The first components is a conductive electro-active polymer and acts a catalyst support and an ion-exchange media. The second component is a catalyst and an acidic medium incorporated or synthesized with the first component to create the polymer catalyst composite.

### CROSS-REFERENCE TO RELATED APPLICATIONS

This application is cross-referenced to and claims priority from U.S. Provisional Application 60/720,174 filed Sep. 23, 2005, which is hereby incorporated by reference.

### FIELD OF THE INVENTION

The invention relates generally to membrane electrode assemblies in fuel cells. More particularly, the present invention relates to devices and methods that will eliminate the water and methanol crossover problems in state-of-the-art direct methanol fuel cells.

### BACKGROUND OF THE INVENTION

Direct Methanol Fuel Cells (DMFCs) have attracted significant attention as a viable power/energy source for a variety of applications ranging from consumer electronics to automotive propulsion units. The key advantages offered by DMFCs include simple operating parameters (temperature and pressure), simple system design and the logistics of liquid methanol fuel (supply, storage, handling and cost). However, the commercialization of DMFC faces some significant technology hurdles that translate into an expensive, unreliable and bulky system.

A DMFC construction incorporates a fuel cell stack, a Balance of Plant (BOP) portion, a controller and a power conditioning sub-system. The fuel cell stack includes a Membrane Electrode Assembly (MEA), gas diffusion layers, gaskets, sealants and separator plates. The fuel cell stack is the electrochemical backbone of the fuel cell system where the chemical energy of the methanol fuel is converted to electrical energy via electrochemical reactions occurring at the MEA.

At each MEA within the fuel cell stack, the methanol fuel is oxidized at the anode and oxygen (or pure air) is reduced at the cathode. In the fuel cell stack there is a substantial amount of undesired methanol and water crossing over from the anode side (positive electrode) to the cathode side (negative electrode) through the conventional polymeric membrane electrolyte (Nafion) used in the state-of-the-art DMFCs. Water crossover through the polymeric membrane electrolyte is primarily the result of electro-osmotic drag whereas methanol crossover is the result of diffusion due to a methanol concentration gradient between the anode and cathode compartments. This crossover results in a variety of problems that lower the overall efficiency of the system and require a complicated BOP for an efficient operation of the fuel cell system.

The water permeation through the membrane coupled with the conversion of water in the methanol oxidation reaction at the anode leads to water starvation at the anode and subsequently a water imbalance. To address the methanol crossover problem the methanol feed is diluted to lower the concentration gradient thus reducing the crossover. Hence, the functioning of the subsystems constituting the BOP is intricately coupled.

In summary, the most critical problem in a DMFC involves the management of water imbalance at the anode and cathode. Water losses on the anode side due to water permeation through the membrane electrolyte and due to the conversion of water in the methanol oxidation reaction lead to water starvation at the anode and subsequent slow reaction kinetics on the anode side.

Additionally, to have a commercial fuel cell system that is water autonomous, neat or commercially available methanol should be the only fuel fed to the fuel cell. However, the neat methanol fuel needs to be strongly diluted in-situ in a bulky methanol-water mixing tank to reduce the methanol crossover across the membrane electrolyte due to concentration gradients. These problems are traditionally being addressed by either trying to develop a membrane that would restrict methanol and water permeation or by employing bulky and power consuming equipment (condensers, mixing tank, cooling fans for the condenser and heat and mass exchangers) for recycling water back to the anode from the cathode outlet stream. Due to the lack of a suitable membrane that could restrict water and methanol crossover the latter option is the presently the way to solve these problems. However, this approach leads to low power density as well as huge parasitic power consumption from multiple components and sub-systems constituting the balance of plant or auxiliary systems in a DMFC. Accordingly, it would be considered an advance in the art to develop a membrane that would restrict methanol and water permeation.

### SUMMARY OF THE INVENTION

The invention provides a polymer catalyst composite that acts as a membrane or a membrane electrode assembly in a direct methanol fuel cell. The polymer catalyst composite distinguishes two components. The first component is a conductive electro-active polymer and acts a catalyst support and an ion-exchange media. Examples of suitable conductive electro-active polymer are a polypyrrole, a polyaniline, a polythiophene, a polyacetylene, a poly(para-phenylene), a poly(dipheylamine), a poly(indole), a poly(fluorine), a polyazulene or a polyacene. The second component is a catalyst and an acidic medium. Examples of the second component are a heteropolyanion, a polyoxometalate, a heteropolyacid, or a polyelectrolyte. The first component is synthesized or incorporated with the second component to create the polymer catalyst composite.

### BRIEF DESCRIPTION OF THE FIGURES

The present invention together with its objectives and advantages will be understood by reading the following description in conjunction with the drawings, in which:

FIG. 1 shows the electro-dynamic movement of the mobile cation (proton) within Component 1 of the polymer composite membrane as a result of two oxidation states on either sides of the polymer composite membrane according to the present invention.

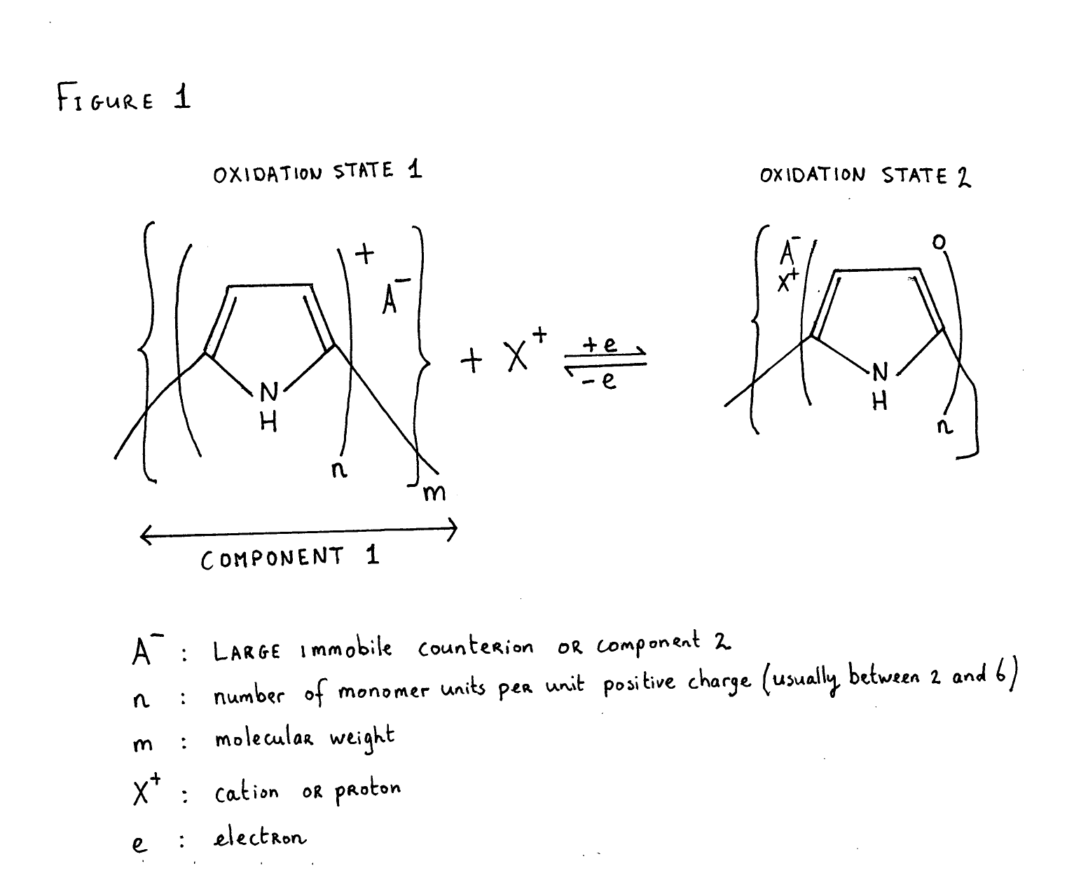

FIG. 2 shows an exemplary embodiment of polymer composite membrane according to the present invention.

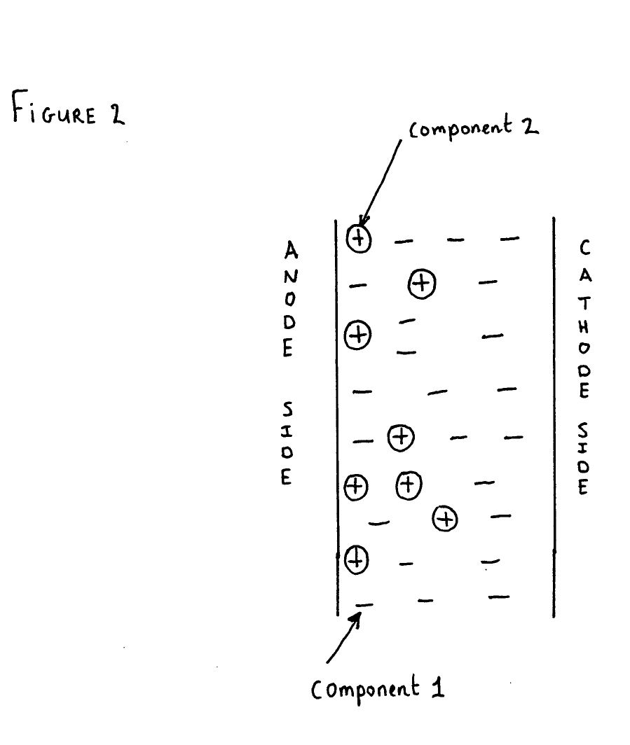

FIG. 3 shows an exemplary embodiment of a DMFC according to the present invention and an embodiment of the reaction occurring at Component 2 incorporated within Component 1.

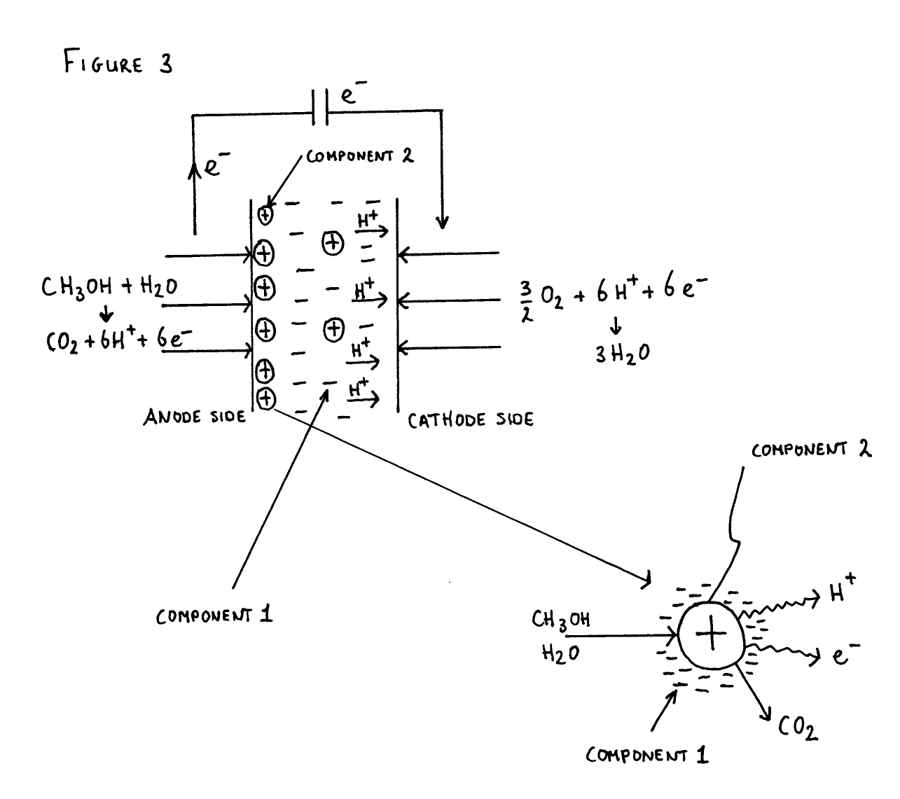

### DETAILED DESCRIPTION OF THE INVENTION

This invention provides an elegant design of a polymer-catalyst composite that will function as a Membrane-Electrode Assembly (MEA) in a Direct Methanol Fuel Cell (DMFC). The advantage of the invention is that it will eliminate or at least significantly reduces, the water and methanol crossover problems in state-of-the-art DMFCs. The design of the polymer-catalyst composite employs two components: component 1, which is a conductive electro-active polymer (CEP), and component 2, which is a heteropolyanion, a polyoxometalate, or a polyelectrolyte. Both components have multi-functional usage within the MEA.

Component 1

Component 1 (CEP) functions as catalyst support and provides electronic and ionic (H+ion) conduction while improving the charge transfer kinetics for the electrons and the protons within the anode. The CEP further acts as an ion-exchange media for assisting ion (proton) transfer from the anode to the cathode side.

Component 1 could include conducting polymers such as, but not limited to, polypyrroles, polyaniline, polythiophene, polyacetylene, poly(para-phenylene), poly(dipheylamine), poly(indole), poly(fluorine), polyazulene, polyacenes, or other conducting polymers with the characteristics described herein for component 1. These CEPs exhibit significant conductivity when the polymer is switched between different oxidation states. Thus, ionic species such as protons can be electrochemically transported by maintaining a difference in oxidation states across the conductive polymer. If the conductive polymer is synthesized using a large immobile counterion, such as polyoxometalates, heteropolyacids, heteropolyanions, or polyelectrolytes, the cation exchange capacity of the polymer increases thus enhancing the proton transfer in the case of DMFC. Additionally, the conductive polymers composite that include a large hydrophobic counterion would provide a barrier to water transport across the composite.

Typically, in the perfluorosulfonic acid-based membrane systems (Nafion systems) comprehensive research has shown that proton transport is very dependent on the hydration level of the Nafion membrane. The key modes of proton transport are the following:

(1) proton hopping along the pore surface i.e., surface diffusion, in an interfacial zone of roughly 3-5A°, for which the dielectric constant is substantially lower than that in the bulk zone,

(2) Grotthus diffusion in the pore bulk, and

(3) ordinary en masse diffusion (or vehicular diffusion) of hydronium (H₃0⁺) ions.

In the vehicular mechanism, a proton rides along with the diffusing water (or vehicle) as hydronium ion. In fact, it also takes along strongly bonded water molecules in the first hydration shell, that is, electro-osmotic drag. Thus, the dominant proton transport modes translate into significant water transport across the membrane. In this invention, the dominant proton transfer is due to the movement of the cation (proton) as protons are electrochemically transported by maintaining a difference in oxidation states across the conductive polymer. If the conductive polymer is synthesized using a large immobile counterion, such as polyoxometalates, heteropolyacids, heteropolyanions, or polyelectrolytes, the cation exchange capacity of the polymer increases thus enhancing the proton transfer in the case of DMFC. This unique property of conductive polymers results in significant resistance to methanol and water permeability thus providing a major operational advantage over the perfluorsulfonic acid-based membranes.

Conductive polymers named herein represent a class of materials possessing significant electronic conductivity. This characteristic makes them attractive as catalyst support for DMFCs and other types of Proton-Exchange-Membrane Fuel Cells (PEMFCs) since they offer good interfacial contact area for three phases, namely: (i) the catalyst, (ii) the ion (proton)-exchange medium and (iii) the electronic conductor medium. A critical requirement for candidates for catalyst support in a DMFC or PEMFC is to have an acid-resistant ligand system that will bind strongly to the graphite electrodes to facilitate rapid electron ejection or removal from the intermediates produced during the catalytic reaction. Conductive polymers satisfy this requirement and thus provide an excellent substrate for electron transfer from the catalyst site to the graphite electrode. Conductive polymers, unlike the traditional carbon-based catalyst supports used in DMFC or PEMFC, also exhibit significant resistance to carbon-monoxide poisoning.

Component 2

Component 2 functions as a catalyst for methanol oxidation and as an acidic medium that further enhances the proton transfer across the electrolyte. Examples of component 2 are, for example, heteropolyanion, polyoxometalate, heteropolyacid, polyelectrolyte, or polymers possessing the following characteristics. For example, these components possess high-bronsted acidity (i.e. with a Hamilton acidity above 15) and have a discrete ionic structure with mobile anions and counter cations that will lead to high proton mobility when incorporated with component 1. Incorporation of component 2 in component 1 as a counterion influences the cation (in the case of the DMFC the cation is proton or H⁺) exchange property of the conductive polymer, i.e. component 1. Heteropolyacids not only have very strong bronsted acidity that is almost approaching that of superacids but they are also efficient oxidants since they exhibit fast reversible multi-electron redox transformation under mild reaction conditions. Heteropolyacids have a discrete ionic structure comprising of mobile anions and counter cations—this unique characteristic lends itself to high proton mobility. The Polyoxometalates are composed of d° metal cations specifically Vanadium (V), Molybdenum (Mo) and Tungsten (W) in varying combinations and oxide anions. These are held together by metal-oxygen bonds. The heterpolyanions contain one or more “d” or “p” block heteroatom cations (usually denoted by X) in addition to the metal cations and oxide anions (XₐM_{b}O_{c}⁴) present in a Polyoxometalate. The substitution of one or more of the addenda atoms (Tunsgten, Molybdenum, Vanadium) in the Keggin anion framework of the heterpoly compound by either transition metals (Cr, Mn, Fe, Co, Ni, and/or Cu) or by another addenda atom (mixed-addenda type Keggin structure) enhances the oxidation property of the heteropolyacids thus making it very attractive for methanol oxidation in a DMFC.

Methanol oxidation over Non-precious Transition Metal Oxides is well studied by the scientific community however the use of Non-Precious Transition Metal Oxides in Direct Methanol Fuel Cells has been extremely difficult to establish. The primary reason for this has been the un-stability of the Transition Metal Oxide catalysts in the highly acidic environment of the perfluorosulfonic acid-based DMFC systems. The approach as described herein of using a non-perfluorosulfonic acid electrolyte enhances the possibility of deploying the transition metal oxide catalysts which not only have a high reaction rate for methanol oxidation but offer a high cost advantage compared to the noble-metal catalysts (Platinum-Ruthenium) typically employed in DMFC systems. Typically, the order of the methanol oxidation reaction using a non-precious transition metal oxide catalyst is in the range of 1 to 1.5 with respect to methanol concentration and between 0 and 0.7 with respect to oxygen concentration.

Additionally, during the methanol oxidation reaction using the heteropolyanion, polyoxometalate, heteropolyacid, polyelectrolyte as catalyst the electrons produced near the transition metal sites will be ameliorated by the heteropolyanion, polyoxometalate, heteropolyacid, polyelectrolyte thus promoting the effect of these as intermediate-CO oxidation catalysts.

Synthesis of the Polymer-catalyst Composite

The composite including component 1 (CEP) and component 2 (a polyoxometalate, a heteropolyacid, a polyelectrolyte or heteropolyanion) can be synthesized by an oxidation of a monomer. This monomer is the backbone of the CEP. The oxidation process can be carried out by three methods, namely: (i) by an electropolymerization process in an electrochemical cell by the application of an external potential at an electrode or (ii) by a chemical polymerization process by utilizing a chemical oxidant or (iii) by a photochemically/enzyme-catalyzed process. Each of these processes produces an end product with a different physical form and different chemical properties. The electrochemical method (method (i)) produces a membrane structure and is thus the preferred option for the fuel cell application.

Examples of ratios of component 1 to component 2 are for example from 1:0.1. Examples of molecular weights for component 1 ranges from several hundreds up to 150,000 and for component 2 ranges from 100 to 5000.

The electro-polymerization process for fabricating a polymer-catalyst composite according to the present invention includes the oxidation of the monomer for the CEP at a suitable electrode. The electrochemical cell used for making this composite includes a working electrode (anode), an auxiliary electrode, a reference electrode (in the case of a 2-electrode cell, the reference electrode will be eliminated), an electrolyte, the monomer for the CEP being synthesized and component 2.

The key design factors that could influence reproducibility and the efficiency of the process include the design for thermal management and for fluid transfer within the electrochemical cell. High temperatures can promote some undesired products as a result of side reactions thus necessitating the need for regulating the cell temperature. It is important to reduce any mass transfer-induced resistances within the cell thus the cell design needs to have an efficient flow of the reactants and products to and from the various electrodes, respectively.

The choice of the electrode material, size and physical structure of the working electrode will determine several key phenomena including the oxidation of the monomer, the deposition of the desired polymer composite on the working electrode surface and the degree of adhesion of the polymer to the electrode surface. The electrolyte employed in the electrochemical cell is chosen after satisfying several key criteria such as its capability to dissolve the monomer and the second component, its stability within the potential range that will be applied in the electrochemical cell and its reaction with the other components within the cell (electrode, monomer, second component) to produce any desirable or undesirable reactions.

A positive potential will be applied to the working electrode (anode) resulting in the formation of an insoluble CEP on the electrode surface. The applied potential will determine the oxidation and the polymer formation rate (deposition of the polymer on the electrode might not occur at very low oxidation rates) and in turn the properties (conductivity, etc.,) of the composite polymer. High potentials may end up in a potential regime where polymer over-oxidation tends to occur. A constant current method electro-polymerization method can also be used in the instance of a 2-electrode cell. The constant current approach leads to the formation of even polymer membranes. The concentration of the second component can be varied and this component will be incorporated between the planes of the CEP.

The electro-polymerization process for preparing the composite involves several steps. The first step is the monomer oxidation step, the second step in the polymerization process is the radical-radical coupling step, and the third step is a de-protonation or proton(s) removal step followed by an oxidation step. During the second step, the presence of component 2 that will be incorporated in the CEP plays a significant role.

Applications and Uses

The polymer catalyst composite is usable in a variety of applications. For example:
1. The composite could act as a MEA for a DMFC or a PEMFC. The composite will contact methanol in the case of a DMFC or hydrogen in the case of a PEMFC on one end and air or oxygen on the other end.
2. The composite could act as a MEA where protons generated from the methanol oxidation reaction in the case of a DMFC or from hydrogen oxidation reaction in the case of a PEMFC will be the only charged ions transported across the composite and electrons will be transported across the external circuit.
3. The composite could act as a barrier for electron transfer.
4. The composite could act as a barrier to methanol and water permeation.

In the composite component 1 acts as follows:
1. an electrolyte for proton exchange in a DMFC or in a PEMFC.
2. a catalyst support in a DMFC or PEMFC.
3. to implement the dual function of electrolyte (proton exchange) and as catalyst support (electron transfer) in a DMFC or PEMFC.

In the composite component 2 acts as follows:
1. a catalyst for methanol oxidation in a DMFC.
2. an acid medium for proton conduction in a DMFC or a PEMFC.
3. to implement the dual function of a catalyst and for proton transport in a DMFC or a PEMFC.
4. a large immobile counterion incorporated in a CEP to enhance the cation or proton exchange in a DMFC or PEMFC.
5. to eliminate expensive platinum electrocatalyst as the catalyst of choice in DMFC.

In the composite the combination of component 1 and 2 act as follows:
1. a MEA in a DMFC or a PEMFC.
2. a proton-exchange media in a DMFC or a PEMFC.
3. a way to circumvent any need for water to transport protons across the electrolyte in a DMFC or for proton exchange in a PEMFC.
4. the electrolyte media to eliminate water and methanol permeation across the electrolyte.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed is:

1. A direct methanol fuel cell, comprising:
a polymer catalyst composite, wherein said polymer catalyst composite acts as a membrane electrode assembly in said direct methanol fuel cell, wherein said polymer catalyst composite comprises a first component as a catalyst support and an ion-exchange media, and a second component as a catalyst and an acidic medium, wherein said first component is synthesized or incorporated with said second component.

2. The direct methanol fuel cell as set forth in claim 1, wherein said first component is a conductive electro-active polymer.

3. The direct methanol fuel cell as set forth in claim 1, wherein said first component is a polypyrrole, a polyaniline, a polythiophene, a polyacetylene, a poly(para-phenylene), a poly(dipheylamine), a poly(indole), a poly(fluorine), a polyazulene or a polyacene.

4. The direct methanol fuel cell as set forth in claim 1, wherein said second component is a heteropolyanion, a polyoxometalate, a heteropolyacid, or a polyelectrolyte.

5. The direct methanol fuel cell as set forth in claim 1, wherein the one or more addenda atoms in the Keggin anion framework of said second component is substituted by a transition metal for effecting the methanol oxidation in said direct methanol fuel cell.

6. The direct methanol fuel cell as set forth in claim 5, wherein said transition metal is Cr, Mn, Fe, Co, Ni or Cu.

7. The direct methanol fuel cell as set forth in claim 5, wherein said one or more addenda atoms are Tunsgten, Molybdenum or Vanadium.

8. A direct methanol fuel cell, comprising:
a polymer catalyst composite, wherein said polymer catalyst composite acts as a membrane electrode assembly in said direct methanol fuel cell, wherein said polymer catalyst composite comprises a first component being a conductive electro-active polymer, and a second component being a catalyst and an acidic medium, wherein said first component is synthesized or incorporated with said second component.

9. The direct methanol fuel cell as set forth in claim 8, wherein said conductive electro-active polymer is a catalyst support and an ion-exchange media.

10. The direct methanol fuel cell as set forth in claim 8, wherein said conductive electro-active polymer is a polypyrrole, a polyaniline, a polythiophene, a polyacetylene, a poly(para-phenylene), a poly(dipheylamine), a poly(indole), a poly(fluorine), a polyazulene or a polyacene.

11. The direct methanol fuel cell as set forth in claim 8, wherein said second component is a heteropolyanion, a polyoxometalate, a heteropolyacid, or a polyelectrolyte.

12. The direct methanol fuel cell as set forth in claim 8, wherein the one or more addenda atoms in the Keggin anion framework of said second component is substituted by a transition metal for effecting the methanol oxidation in said direct methanol fuel cell.

13. The direct methanol fuel cell as set forth in claim 12, wherein said transition metal is Cr, Mn, Fe, Co, Ni or Cu.

14. The direct methanol fuel cell as set forth in claim 12, wherein said one or more addenda atoms are Tunsgten, Molybdenum or Vanadium.

15. A membrane in a direct methanol fuel cell, comprising:
a polymer catalyst composite, having a first component being a conductive electro-active polymer, and a second component being a catalyst and an acidic medium, wherein said first component is synthesized or incorporated with said second component.

16. The direct methanol fuel cell as set forth in claim 15, wherein said conductive electro-active polymer is a catalyst support and an ion-exchange media.

17. The direct methanol fuel cell as set forth in claim 15, wherein said conductive electro-active polymer is a polypyrrole, a polyaniline, a polythiophene, a polyacetylene, a poly(para-phenylene), a poly(dipheylamine), a poly(indole), a poly(fluorine), a polyazulene or a polyacene.

18. The direct methanol fuel cell as set forth in claim 15, wherein said second component is a heteropolyanion, a polyoxometalate, a heteropolyacid, or a polyelectrolyte.

19. The direct methanol fuel cell as set forth in claim 15, wherein the one or more addenda atoms in the Keggin anion framework of said second component is substituted by a transition metal for effecting the methanol oxidation in said direct methanol fuel cell.

20. The direct methanol fuel cell as set forth in claim 19, wherein said transition metal is Cr, Mn, Fe, Co, Ni or Cu.

21. The direct methanol fuel cell as set forth in claim 19, wherein said one or more addenda atoms are Tunsgten, Molybdenum or Vanadium.
